(19) United States
(12) Patent Application Publication
(10) Pub. No.: US 2021/0216073 A1
(43) Pub. Date: Jul. 15, 2021

(54) VEHICLE CONTROL SYSTEM, VEHICLE CONTROL METHOD, AND PROGRAM

(71) Applicant: MITSUBISHI HEAVY INDUSTRIES, LTD., Tokyo (JP)

(72) Inventors: Ryoji ARAKI, Tokyo (JP); Yasuo FUJISHIMA, Tokyo (JP); Kazushige TAKAKI, Tokyo (JP)

(21) Appl. No.: 17/142,732

(22) Filed: Jan. 6, 2021

(30) Foreign Application Priority Data
Jan. 10, 2020 (JP) 2020-003131

(51) Int. Cl. G05D 1/02; G05D 1/00; G06K 9/00

(52) U.S. Cl. CPC G05D 1/0212; G05D 2201/0216; G06K 9/00201; G05D 1/0094

(57) ABSTRACT

[Problem] Provided is a vehicle control system that can, without needing to specify a self-position based on external reference data, cause a vehicle to arrive at an object with satisfying required conditions for the position and orientation of a vehicle when the vehicle arrives at the object corresponding to the position and orientation of the object.

[Solution] The vehicle control system includes a detection device that detects a positional relationship between two reference points of the vehicle and two feature points of the object and a control device that determines a movement route of the vehicle on the basis of only information indicative of the positional relationship between the two reference points and the two feature points detected by the detection device. The control device includes a first control unit that generates a route plan and determines the movement route of the vehicle according to the route plan, and a second control unit that determines the movement route of the vehicle by direct feedback, and the first control unit and the second control unit are provided to be switchable in determining the movement route.

### CROSS-REFERENCE TO RELATED APPLICATIONS

This application claims the benefit of priority to Japanese Patent Application Number 2020-003131 filed on Jan. 10, 2020. The entire contents of the above-identified application are hereby incorporated by reference.

### TECHNICAL FIELD

The present disclosure relates to a vehicle control system, a vehicle control method, and a program.

### BACKGROUND ART

A known method of determining a movement route for automatically moving a forklift, i.e., a moving body, includes, on the basis of information from a range sensor provided on the forklift and map data information input in advance, specifying a self-position in an area indicated by the map data and determining a movement route to a target position (see JP 2017-182502 A, for example).

### SUMMARY

The method described in JP 2017-182502 A presupposes that a self-position is specified on the basis of a combination of information from the range sensor and external reference data information, i.e., map data. Thus, the method described in JP 2017-182502 A cannot be adopted in conditions where external reference data is not available or external reference data is difficult to access.

In addition, the method described in JP 2017-182502 A includes a control method for moving a forklift when the forklift is close to some extent to a pallet, the control method including moving the forklift while sequentially correcting approach trajectory data prepared in advance. However, it is unclear what kind of data this approach trajectory data is. Also, it is unclear how this non-specified approach trajectory data is corrected. Thus, the method described in JP 2017-182502 A is difficult to employ.

An object of the present disclosure is to provide a vehicle control system, a vehicle control method, and a program that can, without needing to specify a self-position based on external reference data, cause a vehicle to arrive at an object with satisfying required conditions for the position and orientation of a vehicle when the vehicle arrives at the object corresponding to the position and orientation of the object.

To solve the problems described above and achieve the object described above, a vehicle control system according to at least one embodiment of the present disclosure is a vehicle control system configured to cause a vehicle to arrive at an object with satisfying required conditions for a position and orientation of the vehicle in a two-dimensional plane when the vehicle arrives at the object corresponding to a position and orientation of the object in the two-dimensional plane, the vehicle control system included a detection device provided on the vehicle, the detection device is configured to detect a positional relationship between two reference points of the vehicle and two feature points of the object, and a control device configured to determine a movement route of the vehicle on the basis of only information indicative of the positional relationship detected by the detection device. The control device includes a first control unit configured to generate a route plan on the basis of information indicative of the positional relationship and determine the movement route according to the route plan, and a second control unit configured to determine the movement route by direct feedback on the basis of information indicative of the positional relationship, and

the first control unit and the second control unit are provided to be switchable on the basis of the positional relationship, in determining the movement route.

According to this configuration, the vehicle control system can, without needing to specify a self-position of the vehicle based on external reference data, cause a vehicle to arrive at an object with satisfying required conditions for the position and orientation of a vehicle when the vehicle arrives at the object corresponding to the position and orientation of the object.

In this configuration, the control device may determine the movement route by the second control unit when the vehicle arrives in a switching region where the vehicle can be caused to arrive at the object with satisfying the conditions under movement and steering constraints of the vehicle, and determine the movement route by the first control unit when the vehicle is outside the switching region.

In this configuration, the switching region may be facing the object with respect to the orientation of the object.

In this configuration, the switching region may be predetermined on the basis of specifications of the vehicle.

In this configuration, the first control unit may update the route plan at a predetermined time period.

In this configuration, the second control unit may set an intermediate point between an arrival target position and a self-position on a movement route of an imaginary holonomic vehicle capable of movement in all directions and generates a movement route for moving the vehicle to the arrival target position through the intermediate point.

This configuration may further include a guidance unit configured to guide the vehicle to move close to the object when the object is outside a detection range of the detection device.

A vehicle control method according to at least one embodiment of the present invention is a vehicle control method for causing a vehicle to arrive at an object with satisfying required conditions for a position and orientation of the vehicle in a two-dimensional plane when the vehicle arrives at the object corresponding to a position and orientation of the object in the two-dimensional plane, the vehicle control method includes, detecting a positional relationship between two reference points of the vehicle and two feature points of the object, and determining a movement route on the basis of only information indicative of the positional relationship detected in the detecting. In the determining, a first control, in which a route plan is generated on the basis of information indicative of the positional relationship and the movement route is determined according to the route plan, and a second control, in which the movement route is determined by direct feedback on the basis of information indicative of the positional relationship, are switchable on the basis of the positional relationship in determining the movement route.

A program according to at least one embodiment of the present disclosure is a program for causing an information processing device to implement a function that causes a vehicle to arrive at an object with satisfying required conditions for a position and orientation of the vehicle in a two-dimensional plane when the vehicle arrives at the object corresponding to a position and orientation of the object in the two-dimensional plane, the program causing the information processing device to function as, a control means configured to determine a movement route on the basis of only information indicative of a positional relationship detected by a detection device provided on the vehicle, the detection device being configured to detect a positional relationship between two reference points of the vehicle and two feature points of the object. The control means includes a first control unit configured to generate a route plan on the basis of information indicative of the positional relationship and determine the movement route according to the route plan, and a second control unit configured to determine the movement route by direct feedback on the basis of information indicative of the positional relationship, and the first control unit and the second control unit are switchable on the basis of the positional relationship in determining the movement route.

According to at least one embodiment of the present disclosure, the vehicle control system can, without needing to specify a self-position based on external reference data, cause a vehicle to arrive at an object with satisfying required conditions for the position and orientation of a vehicle when the vehicle arrives at the object corresponding to the position and orientation of the object.

### BRIEF DESCRIPTION OF DRAWINGS

The disclosure will be described with reference to the accompanying drawings, wherein like numbers reference like elements.

FIG. 1 is a block diagram illustrating a main configuration of a vehicle 1 of a first embodiment.

FIG. 2 is a schematic view illustrating an image captured by a detection unit.

FIG. 3 is an X-Y plan view illustrating a main configuration of a vehicle and a pallet.

FIG. 4 is a schematic diagram illustrating an example of movement control of a vehicle that switches between a route plan and direct feedback.

FIG. 5 is a diagram illustrating the data flow of a control device that is capable of switching between a route plan and direct feedback.

FIG. 6 is a schematic diagram illustrating an example of a switching position at which the method of determining the movement route is switched from a first control unit to a second control unit.

FIG. 7 is a schematic diagram illustrating an example of a switching range corresponding to the orientation of the vehicle with respect to the position and orientation of a pallet.

FIG. 8 is a schematic diagram illustrating an example of a switching range corresponding to the orientation of the vehicle with respect to the position and orientation of a pallet.

FIG. 9 is a schematic diagram illustrating a route plan before and after updating.

FIG. 10 is a schematic diagram illustrating the mechanism of movement control of a holonomic vehicle.

FIG. 11 is a diagram illustrating the displacement between a target position and the position after movement due to the output of a second control unit only according to Equation (3) and Equation (4).

FIG. 12 is a schematic diagram illustrating a movement route for moving a vehicle through an intermediate point to a target position.

FIG. 13 is a diagram illustrating the data flow by a second control unit of the fourth embodiment.

FIG. 14 is a schematic diagram illustrating the relationship between a guidance unit and a vehicle.

### DESCRIPTION OF EMBODIMENTS

Detailed descriptions will be given below of embodiments according to the present disclosure on the basis of the drawings. Note that, the invention is not limited to the embodiments. In addition, the constituent elements in the embodiments include those that can be easily replaced by a person skilled in the art or those that are substantially the same. The various constituent elements described hereafter may also be combined, as appropriate.

### First Embodiment

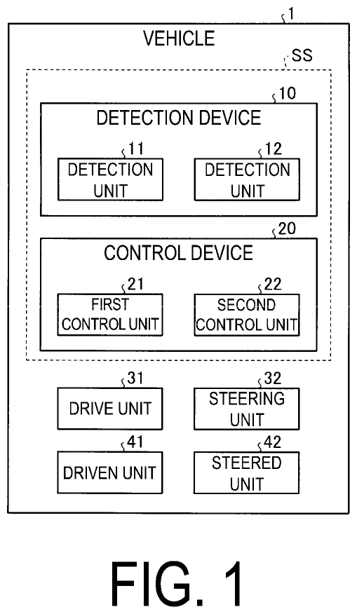

FIG. 1 is a block diagram illustrating a main configuration of a vehicle 1 of the first embodiment. The vehicle 1 includes a detection device 10, a control device 20, a drive unit 31, a steering unit 32, and a driven unit 41. A control system SS of the vehicle 1 of the first embodiment includes the detection device 10 and the control device 20.

The example of a combination of the vehicle 1 and an object, at which the vehicle 1 arrive by moving, described below, is a forklift being the vehicle 1 and a pallet PA being the object. However, as described below, no such limitation is intended.

The detection device 10 detects the positional relationship between the two reference points of the vehicle 1 and two feature points of the pallet PA. The detection device 10 of the first embodiment includes two detection units 11 and 12 that function as a so-called stereo camera. The detection units 11 and 12 are imaging devices that function as so-called digital cameras. The imaging device includes an imaging element such as a complementary metal oxide semiconductor (CMOS) image sensor or a charge coupled device (CCD) image sensor, a circuit for generating image data on the basis of the output of the imaging element, and the like.

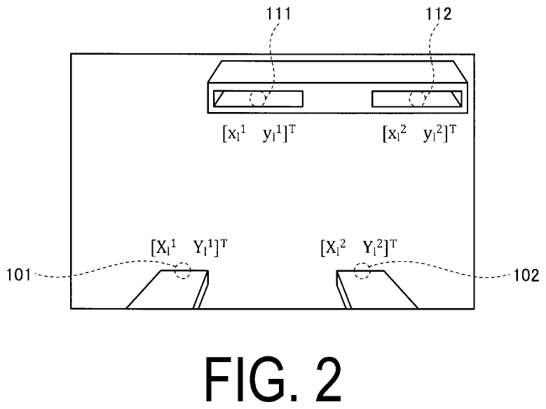

FIG. 2 is a schematic view illustrating an image captured by the detection unit 11. The captured image illustrated in FIG. 2 includes four sets of coordinates of [X₁¹ Y₁¹]^{T}, [X₁² Y₁²]^{T}, and [x₁² y₁²]^{T}. [X₁¹ Y₁¹]^{T} are coordinates indicating the position of the front end of a fork F1 of the vehicle 1 in the image captured by the detection unit 11. [X₁² Y₁²]^{T} are coordinates indicating the position of the front end of a fork F2 of the vehicle 1 in the image captured by the detection unit 11. [x₁¹ y₁²]^{T} are coordinates indicating the position of an opening of an insertion portion G1 of the pallet PA in the image captured by the detection unit 11. [x₁² y₁²]^{T} are coordinates indicating the position of an opening of an insertion portion G2 of the pallet PA in the image captured by the detection unit 11. Note that the superscript T stands for transpose.

Note that the image captured by the detection unit 12 is basically the same with that captured by the detection unit 11. However, because the detection unit 11 and the detection unit 12 are located at different positions on the vehicle 1, the specific positional relationship between the two reference points and the two feature points within the image captured by the detection unit 12 is different from the positional relationship within the image captured by the detection unit 11. Function as a stereo camera is realized on the basis of this difference in positional relationship.

Hereinafter, to distinguish between the two reference points and two feature points in the image captured by the detection unit 11 and the two reference points and two feature points in the image captured by the detection unit 12, the two reference points and two feature points in the image captured by the detection unit 12 are denoted as [Xᵣ¹ Yᵣ¹]^{T}, [Xᵣ² Yᵣ²]^{T}, [xᵣ¹ yᵣ¹]^{T}, and [xᵣ² yᵣ²]^{T}. [Xᵣ¹ Yᵣ¹]^{T} are coordinates indicating the position of the front end of the fork F1 of the vehicle 1 in the image captured by the detection unit 12. [Xᵣ² Yᵣ²]^{T} are coordinates indicating the position of the front end of the fork F2 of the vehicle 1 in the image captured by the detection unit 12. [xᵣ¹ yᵣ¹]^{T} are coordinates indicating the position of an opening of the insertion portion G1 of the pallet PA in the image captured by the detection unit 12. [xᵣ² yᵣ²]^{T} are coordinates indicating the position of an opening of the insertion portion G2 of the pallet PA in the image captured by the detection unit 12.

The “sensor coordinate system derived by considering the positional difference between the detection unit 11 and the detection unit 12 functioning as a stereo camera”, which is derivable on the basis of the relationship between the four sets of coordinates [X₁¹ Y₁¹]^{T}, [X₁² Y₁²]^{T}, [x₁¹ y₁¹]^{T}, and [x₁² y₁²]^{T} and the four sets of coordinates [Xᵣ¹ Yᵣ¹]^{T}, [Xᵣ² Yᵣ²]^{T}, [xᵣ¹ yᵣ¹]^{T}, and [xᵣ² yᵣ²]^{T}, is expressed as [X¹ Y¹]^{T}, [X² Y²]^{T}, [x¹ y¹]^{T}, and [x² y²]^{T}. [X¹ Y¹]^{T} are coordinates indicating the position of the front end of the fork F1 of the vehicle 1. [X² Y²]^{T} are coordinates indicating the position of the front end of the fork F2 of the vehicle 1. [x¹ y¹]^{T} are coordinates indicating the position of an opening of the insertion portion G1 of the pallet PA. [x² y²]^{T} are coordinates indicating the position of an opening of the insertion portion G2 of the pallet PA.

In a first embodiment, [X¹ Y¹]^{T} functions as one of the two reference points of the vehicle 1. Also, [X² Y²]^{T} functions as the other of the two reference points of the vehicle 1. [x¹ y¹]^{T} also functions as one of two feature points of the pallet PA. [x² y²]^{T} also functions as the other of the two feature points of the pallet PA. In the first embodiment, the aligning between the two feature points of the pallet PA and the two reference points of the vehicle 1 being established is required as the required conditions for the position and orientation of the vehicle 1 in a two-dimensional plane (X-Y plane) when the vehicle 1 arrives at the pallet PA corresponding to the position and orientation of the pallet PA in the two-dimensional plane.

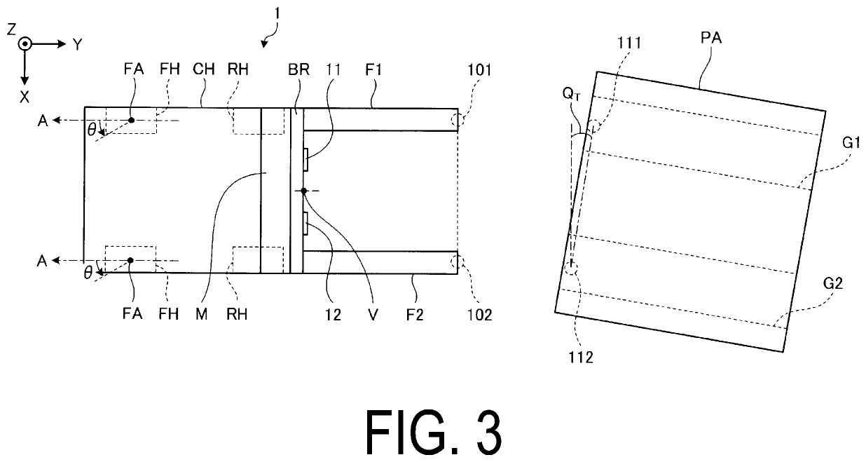

FIG. 3 is an X-Y plan view illustrating a main configuration of the vehicle 1 and the pallet PA. As illustrated in FIG. 3, the insertion portions G1 and G2 are holes provided in the pallet PA where the forks F1 and F2 of the vehicle 1 can be inserted.

The detection unit 11 and the detection unit 12 that function as a stereo camera are provided on the vehicle 1 with a position of the detection unit 11 and a position of the detection unit 12 being different positions in the X-Y plane view. In FIG. 3, the detection unit 11 and the detection unit 12 are provided at positions on opposite sides of a coordinate point V of the vehicle 1. Note that the coordinate point V illustrated in FIG. 3 is the intersection position of a middle line in the direction, in which the fork F1 and the fork F2 are lined up, and a backrest BR. The detection unit 11 functions as a left camera, and the detection unit 12 functions as a right camera.

The detection unit 11 and the detection unit 12 are provided such that the rear side is included in the imaging range. The rear side is the side on which the forks F1 and F2 extends from the backrest BR of the forklift, i.e., the vehicle 1. Note that the detection units 11 and 12 may be imaging devices capable of capturing an image in a wider range (for example, 360 direction) that includes the back side with respect to the X-Y plane.

The forks F1 and F2 are integrally formed with the backrest BR and can move in the Z direction. A mast M supports the backrest BR allowing the backrest BR to be raised and lowered. The backrest Br is connected to a raising/lowering drive unit (not illustrated) and is raised and lowered by the operation of the raising/lowering drive unit.

The position in the Z direction of the detection units 11 and 12 may be fixed or may be provided to be movable in the Z direction together with the backrest BR. In examples in which the detection units 11 and 12 move in the Z direction, the control device 20 corrects the algorithm for deriving the positional relationship between the vehicle 1 and the pallet PA based on a captured image in accordance with the position of the detection units 11 and 12 in the Z direction.

Note that typically, a side on which a forklift is provided with the arms, such as the forks F1 and F2, are considered to be the front side. However, in the first embodiment, a side of the forks F1 and F2 is the rear side of the vehicle 1. This is because the vehicle 1 of the first embodiment is a four-wheel forklift, with the steered wheels FH being located further from the forks F1 and F2 than the drive wheels RH. Thus, the movement control for the vehicle 1, with the steered wheels FH being the front wheels and the drive wheels RH being the rear wheels, can be applied. In other words, moving forward is a case where the vehicle 1 moves in the direction of an arrow A in FIG. 3, in which the steering angle (θ) is 0°. Additionally, in the first embodiment, the angle to the counterclockwise direction with respect to the arrow A in the X-Y plane is a positive steering angle (θ). The angle to the clockwise direction on the other side of the arrow A is a negative steering angle (−θ). The positive/negative of the steering angle may be reversed. In addition, the movement control of the vehicle 1 in this example may be applied to the control device 20 with reversing the forward and backward.

The combination of the captured image from the detection unit 11 and the captured image from the detection unit 12 function as a stereo camera enabling stereoscopic vision. Also, processing by the control device 20, described below, enables the calculation of the distance and the like to the pallet PA included in the two captured images.

The control device 20 determines the movement route of the vehicle 1 on the basis of only information indicative of the positional relationship between the two reference points and the two feature points detected by the detection device 10. As illustrated in FIG. 1, the control device 20 includes a first control unit 21 and a second control unit 22.

The first control unit 21 performs processing to generate a route plan based on the information indicative of the positional relationship between two reference points and the two feature points and to determine the movement route of the vehicle 1 according to the route plan. The route plan is a route plan according to model predictive control (MPC) in the X-Y plane view of the vehicle 1, for example. The first control unit 21 determines a plurality of waypoints that are set on the movement route, under the assumption of the movement route for the vehicle 1 to arrive at or approach near to the pallet PA. In other words, the route plan generated by the first control unit 21 includes information indicative of a plurality of waypoints. In a case in which the movement route of the vehicle 1 is determined according to the route plan, the control device 20 controls the operation of the drive unit 31 and the steering unit 32 so that the vehicle 1 passes through the plurality of waypoints.

The second control unit 22 performs processing to determine the movement route of the vehicle 1 by direct feedback based on information indicative of the positional relationship between the two reference points and the two feature points. Examples of the basic direct feedback method include visual servoing method such as that described in “Position and Orientation Control of Omnidirectional Mobile Robot by Linear Visual Servoing”, Authors: Atsushi Ozato and Noriaki Maru, Transactions of the JSME series C, Vol. 77, No. 774, pp. 215-224, published Feb. 25, 2011. The second control unit 22 determines the movement route of the vehicle 1 by direct feedback that is able to be applied to the nonholonomic movement control of the vehicle 1, based on such a method.

Note that the control device 20 adopts a position on the X-Y plane of the coordinate point V as “a point (coordinate) for defining a position of the vehicle 1 on the X-Y plane” which has been determined in advance for performing movement control of the vehicle 1. The waypoints through which the vehicle 1 need to pass according to the route plan are determined under the assumption that the coordinate point V passes through the waypoints. When the movement of the vehicle 1 is controlled by direct feedback, the coordinate point V is used as a reference. However, this can be changed as appropriate, and any position of the vehicle 1 can be used as the vehicle 1 coordinates.

The control device 20 is provided to be switchable between the first control unit 21 and the second control unit 22 to determine the movement route of the vehicle 1 on the basis of the positional relationship between the two reference points and the two feature points. That is, the control device 20 is provided to be switchable between the route plan or direct feedback to determine the movement route of the vehicle 1.

By using the route plan, the movement route and the waypoints of the vehicle 1 can be generated openly taking into consideration the turning performance and the movement speed range (from maximum speed to minimum speed) defined by the drive unit 31, the steering unit 32, the driven unit 41, and the steered unit 42 of the vehicle 1. Also when taking into account the turning performance, and a switchback operation is required for the vehicle 1 to arrive at the pallet PA, the generated route plan can include a movement route and waypoints of the vehicle 1 that include a switchback operation. Also, in the route plan, when there is an obstacle that prevents movement of the vehicle 1 between the vehicle 1 and the pallet PA, the generated movement route and waypoints can avoid such obstacles.

However, extremely high accuracy may be required in the positioning problem of nonholonomic vehicles. For example, when the forklift, i.e., the vehicle 1, needs to move so that the forks F1 and F2 are inserted into the insertion portions G1 and G2 of the pallet PA, i.e., the object, the position and attitude (orientation) of the vehicle 1 need to be controlled to cause the vehicle 1 to arrive at the pallet PA with satisfying the condition that the front ends of the forks F1 and F2 do not collide with portions of the pallet PA other than the insertion portions G1 and G2.

Even though positioning may be possible under ideal conditions without sensor measurement error as in a simulation, in reality, errors may be included in the estimated values of the positioning and orientation of the pallet PA based on the output of the detection device 10. Thus, it is difficult to make the vehicle 1 arrive at the pallet PA with satisfying the position and attitude conditions by simply using only a route plan.

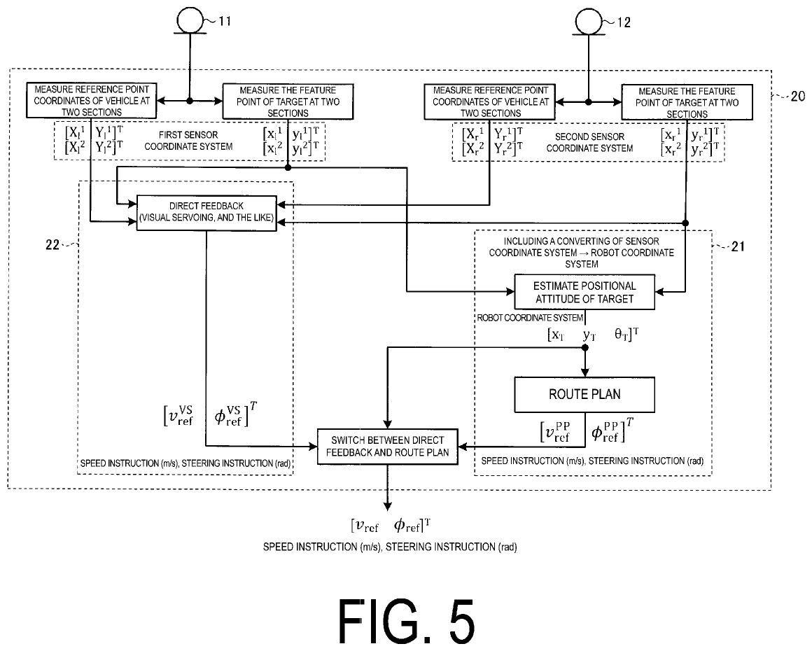

Thus, in the first embodiment, the route plan and direct feedback can be switched depending on the relative relationship between the position and attitude (orientation) of the vehicle 1 and the pallet PA. Note that, in a route plan by the first control unit 21, processing is required to derive a robot coordinate system (p_{T}=[X_{T} Y_{T} θ_{T}]^{T} described below) indicative of the position and orientation of the pallet PA with respect to the position and orientation of the vehicle 1 on the basis of a sensor coordinate system based on the output (captured images) of the detection units 11 and 12. The sensor coordinate system referred here is a coordinate system representing the relationship between the position and orientation of the vehicle 1 and the position and orientation of the pallet PA by coordinates such as, for example, [X¹ Y¹]^{T}, [X² Y²]^{T}, [x¹ y¹]^{T} and [x² y²]^{T} described above. Also, the robotic coordinate system refers to a coordinate system representing the relationship between the position and orientation of the vehicle 1 and the position and orientation of the pallet PA by coordinates representing the position and orientation of the pallet PA using the coordinates of the vehicle 1 (for example, the coordinate point V) as the origin in the X-Y plane illustrated in FIG. 3 or FIG. 5 described below.

On the other hand, in direct feedback by the second control unit 22, a control instruction ([v_{ref}^{VS} φ_{ref}^{VS}]^{T} described below) can be generated for the drive unit 31 and the steering unit 32 without the need for processing to derive a robot coordinate system from the output (the captured image) of the detection device 10. Also, in general, direct feedback has a lighter processing load compared to the route plan. However, with direct feedback, switchback operation and avoiding obstacles are difficult.

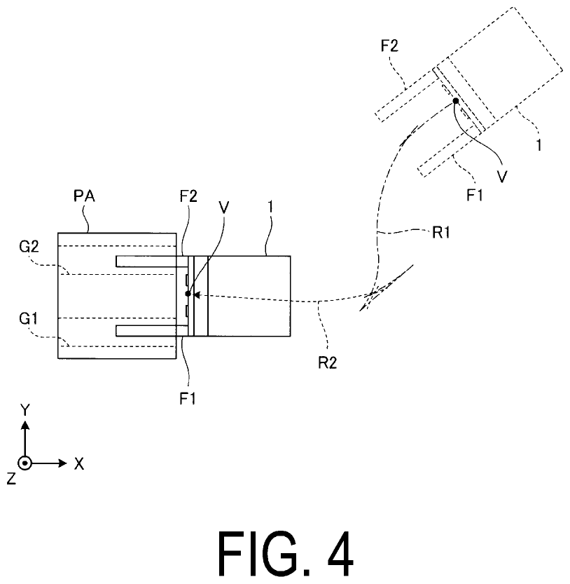

FIG. 4 is a schematic diagram illustrating an example of movement control of the vehicle 1 that switches between a route plan and direct feedback. In FIG. 4, the movement route of the vehicle 1 by the route planning is referred to as a movement route R1, and the movement route of the vehicle 1 by direct feedback is referred to as a movement route R2. As illustrated in FIG. 4, in the first embodiment, until the relationship between the position and orientation of the vehicle 1 and the position and orientation of the pallet PA is in a relationship that does not require switchback operation and avoidance of obstacles, the movement control to bring the vehicle 1 close to the pallet PA is performed by the route plan. After the vehicle 1 is brought close to the pallet PA, the movement control of the vehicle 1 to arrive at the pallet PA is performed by direct feedback. This allows the vehicle 1 to arrive at the pallet PA with satisfying the required conditions for the position and orientation of the forks F1 and F2 of the vehicle 1 when the vehicle 1 arrives at the pallet PA corresponding to the position and orientation of the insertion portions G1 and G2 of the pallet PA.

Note that the vehicle 1 moves forward and inserts the forks F1 and F2 into the insertion portions G1 and G2 after the forks F1 and F2 are aligned to the insertion portions G1 and G2 by matching the two reference points and the two feature points illustrated in FIG. 2. The positional relationship between the vehicle 1 and the pallet PA, after the vehicle 1 moved forward, is illustrated in FIG. 4.

FIG. 5 is a diagram illustrating the data flow of the control device 20 that is capable of switching between a route plan and direct feedback. The data flow illustrated in FIG. 5 is an example of data flow when the detection device 10 is a stereo camera such as the detection units 11 and 12.

First, the four sets of coordinates of [X₁¹ Y₁¹]^{T}, [X₁² Y₁²]^{T}, [x₁¹ y₁¹]^{T}, and [x₁² y₁²]^{T} are derived from the image captured by the detection unit 11 as a first sensor coordinate system. Then, the four sets of coordinates of [Xᵣ¹ Yᵣ¹]^{T}, [Xᵣ² Yᵣ²]^{T}, [xᵣ¹ yᵣ¹]^{T}, and [xᵣ¹ yᵣ²]^{T} are derived from the image captured by the detection unit 12 as a second sensor coordinate system. Note that, in the embodiment, since the detection unit 11 is the left camera, the first sensor coordinate system is also considered to be a left camera coordinate system.

Also, since the detection unit 12 is the right camera, the second sensor coordinate system is also considered to be a right camera coordinate system.

The control device 20 performs processing to derive the first sensor coordinate system and the second sensor coordinate system on the basis of the images captured by the detection unit 11 and the detection unit 12. This processing is a so-called image recognition process. The control device 20 stores in advance a pattern image data for recognizing the forks F1 and F2 and the pallet PA and the insertion portions G1 and G2. The control device 20 performs pattern-matching between the pattern image data and the partial image data of the forks F1 and F2 and the pallet PA and the insertion portions G1 and G2 in the captured image, recognizes the forks F1 and F2 and the pallet PA and the insertion portions G1 and G2, and determines the position of the four sets of coordinates in each captured image. Note that the image recognition processing may be performed by the detection device 10 instead of the control device 20.

Information indicative of the four sets of coordinates of the first sensor coordinate system and information indicative of the four sets of coordinates of the second sensor coordinate system are input to the first control unit 21 and the second control unit 22.

The first control unit 21 performs processing for estimating the positional attitude of the object (for example, the pallet PA).

Specifically, the first control unit 21 derives the sensor coordinate system ([X¹ Y¹]^{T}. [X² Y²]^{T}, [x¹ y¹]^{T}, and [x² y²]^{T}) based on the first sensor coordinate system output from the detection unit 11 and the second sensor coordinate system output from the detection unit 12.

The first control unit 21 derives the robot coordinate system (P_{T}=[X_{T} Y_{T} θ_{T}]^{T}) indicative of the position and orientation of the pallet PA with respect to the position and orientation of the vehicle 1, on the basis of the sensor coordinate system. [X_{T} Y_{T}]^{T} of p_{T} are the coordinates of the pallet PA with the position of the vehicle 1 as the origin. [θ_{T}]^{T} of P_{T} is the angle indicating the orientation of the pallet PA with respect to the vehicle 1. More specifically, [θ]_{T}=0°, when the extension direction of the forks F1 and F2 and the longitudinal direction of the holes of the insertion portions G1 and G2 are parallel with each other, by using the orientation of the vehicle 1 at the time point when the robotic coordinate system is derived as a reference. Also, when the extension direction of the forks F1 and F2 and the longitudinal direction of the holes of the insertion portions G1 and G2 are not parallel, an orientation amount of change (°) for the vehicle 1 is θ_{T} that is required to make the extension direction of the forks F1 and F2 parallel with the longitudinal direction of the holes of the insertion portions G1 and G2.

In this way, in the route plan of the first embodiment, because the robot coordinate system is derived with the position of the vehicle 1 as the origin and the orientation of the vehicle 1 as a reference, there is no need to refer external information (map information, absolute coordinates indicative of the positional relationship between the vehicle 1 and the pallet PA, and the like) to obtain the positional relationship between the vehicle 1 and the pallet PA.

The pallet PA illustrated in FIG. 3 and the like has two orientations where θ_{T}=0° due to the forks F1 and F2 being able to be inserted in either side of the insertion portions G1 and G2. Accordingly, θ_{T} does not exceed 180°. In addition, in the case of a pallet having a rectangular shape in the X-Y plane view and being provided on all four sides with insertion openings (two feature points) of the insertion portions G1 and G2, θ_{T} does not exceed 90°. Also, in the case of an object in which there is only one set of two feature points, θ_{T} may take a value of 360° or less.

The first control unit 21 generates a route plan based on the robot coordinate system. Specifically, the first control unit 21 generates, on the basis of a predetermined algorithm, such as MPC or the like, with respect to the position and orientation of the pallet PA (P_{T}=[X_{T} Y_{T} θ_{T}]^{T}) indicated in the robot coordinate system, a route plan and a plurality of waypoints on the movement route of the vehicle 1 in accordance with the route plan. The first control unit 21 derives [v_{ref}^{PP} φ_{ref}^{PP}]^{T} as a drive instruction for passing through the plurality of waypoints along the movement route.

The second control unit 22 outputs [v_{ref}^{VS} φ_{ref}^{VS}]^{T} as a drive instruction by the direct feedback on the basis of the first sensor coordinate system output from the detection unit 11 and the second sensor coordinate system output from the detection unit 12. More specifically, the second control unit 22 outputs [v_{ref}^{VS} φ_{ref}^{VS}]^{T} for moving the vehicle 1 so to match one of the two reference points with one of the two feature points and match the other of the two reference points with the other of the two feature points.

Note that, in the case of direct feedback, the reference point of the vehicle 1, which is used to match one of the two reference points with one of the two feature points and match the other of the two reference points with the other of the two feature points, may be used as the two reference points, or a preset reference point (for example, the coordinate point V) of the vehicle 1 that is not the two reference points may be used.

The control device 20 outputs the [v_{ref}^{PP} φ_{ref}^{PP}]^{T} or [v_{ref}^{VS} φ_{ref}^{VS}]^{T} as [v_{ref} φ_{ref}]^{T} to the drive unit 31 and the steering unit 32. In [v_{ref} φ_{ref}]^{T}, v_{ref} corresponds to a speed (movement speed) instruction (m/s) to the drive unit 31, and φ_{ref}^{PP} corresponds to a steering instruction (rad) to the steering unit 32. Note that the speed (movement speed) instruction (m/s) can indicate moving forward or moving backward by a plus or minus.

Note that, both of the [v_{ref}^{PP} φ_{ref}^{PP}]^{T} by the first control unit 21 and the [v_{ref}^{VS} φ_{ref}^{VS}]^{T} by the second control unit 22 are derived in ranges of, a speed range (upper limit to lower limit) constrained by the drive unit 31 and the driven unit 41, and a steering angle range constrained by the steering unit 32 and the steered unit 42. Information indicative of the speed range and the steering angle range is predetermined as a constraint condition in the implementation algorithm of the first control unit 21 and the second control unit 22.

Note that the control device 20 is provided as an information processing device including an arithmetic circuit such as a central processing unit (CPU) or a circuit having a similar arithmetic function. At least one of the first control unit 21 or the second control unit 22 may be provided as a function of the control device 20, or may be provided as a separate circuit operating under the control of the control device 20. In the case in which the control device 20 is an information processing device, the content of operation (algorithm) of the control device 20, the first control unit 21, and the second control unit 22 is implemented in a software program that is read by the CPU. In the case in which the control device 20 is a circuit, the circuit is provided as a circuit into which an algorithm is incorporated. Note that a program refers to a software program unless otherwise noted. The program is a program that causes the information processing device including the CPU to implement the functions that is implemented by the control device 20 described in the specification.

In addition, in FIG. 5, the data flow of the first control unit 21 and the data flow of the second control unit 22 are illustrated as capable of being in parallel, however, the first control unit 21 and the second control unit 22 do not actually need to operate in parallel. The control device 20 may operate either the first control unit 21 or the second control unit 22 on the basis of the detection results of the two reference points and the two feature points by the detection device 10. Of course, the first control unit 21 and the second control unit 22 may both operate, and the control device 20 may use the processing content of either one.

The drive unit 31 generates power to move the vehicle 1 forward or backward under the control of the control device 20. Specifically, the drive unit 31 includes a motor that is driven in accordance with [v_{ref}]^{T} of [v_{ref} φ_{ref}]^{T} and operates the driven unit 41 by the driving.

The steering unit 32 generates power for steering the vehicle 1 under the control of the control device 20. Specifically, the steering unit 32 includes a motor that is driven in accordance with [φ_{ref}]^{T} of [v_{ref} φ_{ref}]^{T} and operates the steered unit 42 by the driving.

The driven unit 41 is driven by the drive unit 31 to move the vehicle 1 forward and backward. Specifically, the driven unit 41 of the vehicle 1 corresponds to the drive wheels RH. The steered unit 42 is provided in a manner allowing it to change the steering angle (θ) with respect to a chassis CH of the vehicle 1, and the steering angle (θ) is changed by driving the steering unit 32. Specifically, the steered unit 42 of the vehicle 1 corresponds to the steered wheels FH that are provided in a manner allowing it to change the steering angle (θ) about a rotation axis FA along the Z direction.

As such, the vehicle 1 is provided to be movable in a two-dimensional direction in at least the X-Y plane. Movement of the forklift. i.e., the vehicle 1, in the Z direction orthogonal to the X-Y plane, follows the undulations of the terrain on which the vehicle 1 travels.

According to the first embodiment, the control device 20 determines the movement route of the vehicle 1 on the basis of only information indicative of the positional relationship between the two reference points and the two feature points detected by the detection device 10. Accordingly, the control system SS can, without needing to specifying a self-position of the vehicle 1 based on external reference data, cause the vehicle 1 to arrive at the pallet PA with satisfying required conditions for the position and orientation of the vehicle 1 when the vehicle 1 arrives at the object corresponding to the position and orientation of the pallet PA. In addition, according to the first embodiment, approaching of the vehicle 1 to the pallet PA with performing switchback operation and the like by the route plan and high accuracy positioning of the vehicle 1 with respect to the object by direct feedback can be achieved in a compatible manner.

### Second Embodiment

In the second embodiment, in addition to the configurations and functions described in the first embodiment, a condition is set for the control device 20 to switch between the first control unit 21 and the second control unit 22 that determines the movement route of the vehicle 1. In the following description, items similar to those in the first embodiment are denoted by the same reference signs, and descriptions thereof will be omitted. Note that in the first embodiment, the condition for the control device 20 to switch between method of determining the movement route of the vehicle 1 is not limited to that described in the second embodiment.

The second embodiment will be described using a vehicle 1 movement control flow in which the movement route of the vehicle 1 is first determined by the first control unit 21, and then the method of determining the movement route is switched from the first control unit 21 to the second control unit 22.

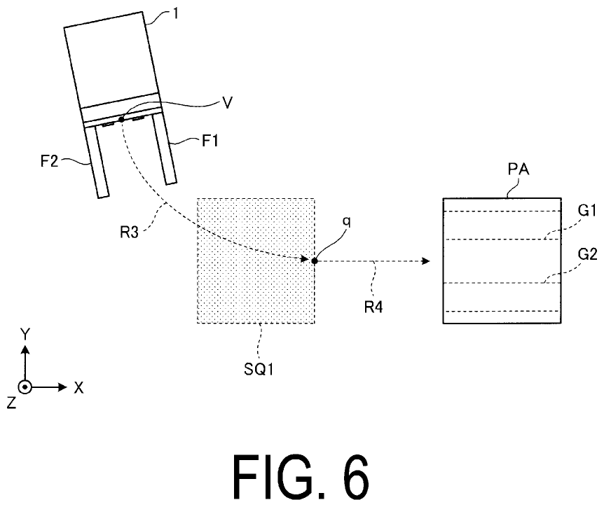

FIG. 6 is a schematic diagram illustrating an example of a switching position at which the method of determining the movement route is switched from the first control unit 21 to the second control unit 22. In FIG. 6, the movement route of the vehicle 1 by the route planning is referred to as a movement route R3, and the movement route of the vehicle 1 by direct feedback is referred to as a movement route R4. The first control unit 21 of the second embodiment performs processing to obtain a target position (q=[x_{PP} y_{PP} θ_{PP}]) where the vehicle 1 faces the pallet PA.

The target position (q) is derived using the following Equation 1.

$$[ Equation 1 ]$$

$$q = p + [ \begin{matrix}D cos {θ}_{T} \\ D sin {θ}_{T} \\ 0\end{matrix} ] \qquad ( 1 )$$

p of Equation (1) is based on the robotic coordinate system (P_{T}=[X_{T} Y_{T} θ_{T}]^{T}) which indicates the position and orientation of the pallet PA and is, for example, p=P_{T}. D in Equation (1) is a predetermined design parameter that represents a separating distance from the target position, i.e., the target position (q) of the route plan, to the robotic coordinate system (pt) indicating the position and orientation of the pallet PA. The first control unit 21 generates a route plan and a plurality of waypoints to allow the vehicle 1 to arrive at the target position (q).

Note that the route plan and the plurality of waypoints may be updated as the vehicle 1 moves. Accordingly, the first control unit 21 updates p and the target position (q) at a predetermined period, for example. As the vehicle 1 approaches the target position (q), the value of q changes to converge to 0.

In the case in which the value of q is equal to or less than a predetermined threshold value, the control device 20 of the second embodiment switches the method of determining the movement route of the vehicle 1 from the first control unit 21 to the second control unit 22. That is, when the value of q is equal to or less than the predetermined threshold value, control is switched from the route plan to direct feedback.

FIG. 6 illustrates an example of a switching region SQ1 where the value of q is equal to or less than the predetermined threshold value. The vehicle 1 determines the movement route until entering the switching region SQ1 by the route plan and determines the movement route after entering the switching region SQ1 by direct feedback. The threshold value is preferably determined, using the target position (q) as a reference, to allow the vehicle 1 to arrive at the pallet PA by direct feedback from any position within a position range (for example, the switching range SQ1 illustrated in FIG. 6) that the vehicle 1 may take in accordance with the threshold.

In this way, in the case in which the vehicle 1 arrived in a switching region (for example, the switching region SQ1) where the vehicle 1 can arrive at the pallet PA with satisfying the conditions under the constraints of the movement and steering of the vehicle 1, the control device 20 of the second embodiment determines the movement route of the vehicle 1 by the second control unit 22. In the case in which the vehicle 1 is outside a switching region, the control device 20 determines the movement route of the vehicle 1 by the first control unit 21. This allows the control device 20 to perform direct feedback when the vehicle 1 enters the switching region SQ1 that is set based on the threshold value, even when the position of the vehicle 1 does not completely match the target position (q).

Also, in the second embodiment, the switching region SQ1 is facing the orientation of the pallet PA. That is, the two reference points of the vehicle 1 and the two feature points of the pallet PA are opposite each other without any components therebetween. According to the second embodiment, direct feedback can be performed from a position of the vehicle 1 where direct feedback control is more reliably performed.

### Modified Example of Second Embodiment

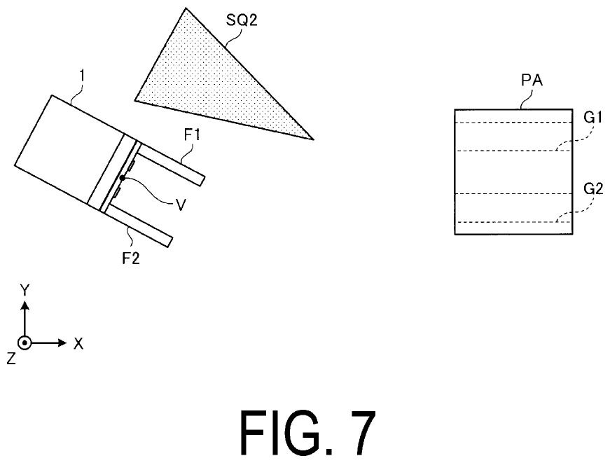

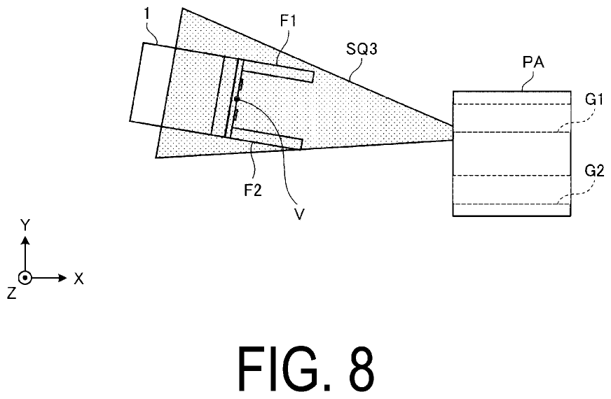

Next, a modified example of the second embodiment will be described with reference to FIGS. 7 and 8. FIGS. 7 and 8 are schematic diagrams illustrating examples of a switching region corresponding to the orientation of the vehicle 1 with respect to the position and orientation of the pallet PA. In the following description of the modified example of the second embodiment, items similar to those in the second embodiment are denoted by the same reference signs, and descriptions thereof will be omitted.

In the modified example of the second embodiment, the switching region, which is applied by depending on “the orientation of the vehicle 1” with respect to the position and orientation of the pallet PA, is changed. The switching region referred here is a region in which the method of determining the movement route of the vehicle 1 is switched from the first control unit 21 to the second control unit 22. That is, in the modified example of the second embodiment, depending on the “orientation of the vehicle 1” with respect to the position and orientation of the pallet PA, the region, where the route plan is switched to direct feedback, is changed.

A switching region SQ2 illustrated in FIG. 7 is a switching region corresponding to the orientation of the vehicle 1 illustrated in FIG. 7. A switching region SQ3 illustrated in FIG. 8 is a switching region corresponding to the orientation of the vehicle 1 illustrated in FIG. 8. In the example illustrated in FIG. 7, the movement route is determined by the route plan as the vehicle 1 is located outside the switching region SQ2. In the example illustrated in FIG. 8, the route plan is switched to direct feedback as the vehicle 1 is located inside the switching region SQ3.

Note that the switching region is a region that is obtained in advance from the constraint conditions determined by the specifications of the vehicle 1 (the speed range and steering angle range of the vehicle 1 described above), the shape of the pallet PA obtained in advance, and the like. Accordingly, in the modified example of the second embodiment, the control device 20 stores information indicative of such a constraint condition or information indicative of a switching region derived in advance on the basis of the constraint condition.

Note that in the second embodiment and the modified example of the second embodiment, the possibility of switching back to the route plan after switching to direct feedback is not eliminated. For example, when alignment of the two reference points and the two feature points are not established by using direct feedback after a certain number of attempts, the direct feedback may be switched to the route plan and the movement route of the vehicle 1 may be re-set.

Note that although FIGS. 7 and 8 illustrate the switching regions SQ2 and SQ3, in practice, the switching region is preset on the basis of the specifications of the vehicle 1 for the orientation of the vehicle 1 with respect to the pallet PA, which is not illustrated in FIGS. 7 and 8.

Thus, in the modified example of the second embodiment, the switching region (for example, the switching regions SQ2 and SQ3) is predetermined on the basis of the specifications of the vehicle 1. According to the modified example of the second embodiment, direct feedback can be performed from a position of the vehicle 1 where direct feedback control is more reliably performed.

### Third Embodiment

In the third embodiment, in addition to the configurations and functions described in the first embodiment, the route plan of the first control unit 21 is more specifically defined. In the following description, items similar to those described above are denoted by the same reference signs, and descriptions thereof will be omitted. Note that the route plan by the first control unit 21 in the first embodiment is not limited to that described in the third embodiment. Also, embodiments in which the second embodiment and the third embodiment are merged are also possible.

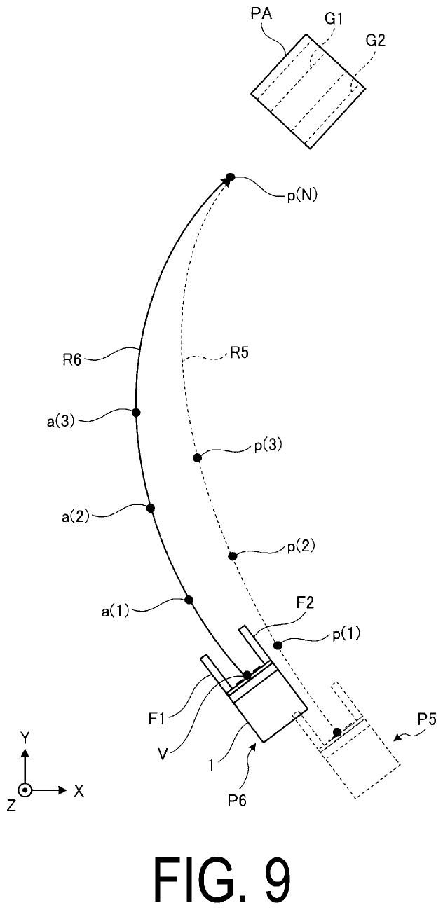

FIG. 9 is a schematic diagram illustrating a route plan before and after updating. As illustrated in FIG. 9, on the basis of a route plan generated when the vehicle 1 is at a positional attitude P5 with respect to the pallet PA, a drive instruction is generated to move the vehicle 1 to a first waypoint p(1) of the movement route R5. On the other hand, when, as a result of detecting the positional relationship between the vehicle 1 and the pallet PA by the detection device 10 after the vehicle 1 has moved in an update time period (Tₛ (seconds)) of the route plan, the vehicle 1 has taken a positional attitude P6 at a position that is not the first waypoint p(1), the first control unit 21 updates the movement route and the waypoint with a route plan from the positional attitude P6. Accordingly, when a movement route R6 is generated, the movement route R5 is discarded. In FIG. 9, in order to indicate the updated waypoints of p(1), p(2), and p(3) located on the movement route R6, the updated waypoints are indicated and distinguished as a(1), a(2), and a(3). Note that p(N) matches before and after updating.

More specifically, the movement route generated by the route plan is a set of a plurality of waypoints p(n), where n=1, 2, . . . , N. The number of waypoints (N) may also be referred to as a prediction horizon. In general, in the case in which the generated movement route is followed, the vehicle 1 periodically measures and estimates the self-positional attitude of the vehicle 1 during movement while referencing information (GPS, map information, and the like) provided from an external source, and the deviation between the self-positional attitude and the route is evaluated so that the vehicle 1 follows the movement route. However, in the third embodiment, information from an external source is not used.

In the third embodiment, during an update time period (Tₛ (seconds)), the vehicle 1 is continually given a control instruction value (u(n)) for arriving at the next waypoint (p(n+1) from the position (p(n)) of the vehicle 1 at the time the most recent route plan is generated. u(n) is [v_{ref}^{PP} φ_{ref}^{PP}]^{T} output from the first control 21 when the position of the vehicle 1 is p(n). The update time period (Tₛ (seconds)) is the time required to move between two consecutive waypoints on the movement route, for example. Here, the relationship between p(n) and p(n+1) is represented by the following Equation (2). Note that f( ) in Equation (2) indicates a motion constraint condition of the vehicle 1 (such as the speed range and steering angle range of the vehicle 1).

p(n+1)=f(p(n),u(n)) (2)

In the case in which MPC is employed for the route plan, it is common to impose constraints such as the vehicle motion constraint condition (f( )) as in Equation (2). Thus, as the output of the first control unit 21, p(n); n=1, 2, . . . , N along with u(n); n=1, 2, . . . ,N−1 are also obtained.

The control device 20 may employ the first control unit 21 to apply u(0) so that the vehicle 1 can then be directed toward the next waypoint p(1) at which the vehicle 1 needs to arrive next. However, in practice, external factors affect the vehicle 1, making it difficult for the vehicle 1 to accurately arrive, without deviating at all, at the waypoint p(1) on an ideal movement route. That is, the position where the vehicle 1 actually arrives is often a position that contains an error with respect to the waypoint p(1). In the third embodiment, this error is tolerance. This is because, by generating the route plan and the waypoints again from the location that includes the error for the ideal waypoint p(1), the route plan can be continuously updated taking into account the error. By making the update time period (Tₛ (seconds)) shorter within the range allowable by the processing load generated in the first control unit 21, the convergence (optimization) of the movement route by the first control unit 21 can be more satisfactorily performed.

In this way, the first control unit 21 of the third embodiment updates the route plan at a predetermined time period (for example, the update time period (Tₛ (seconds)). According to the third embodiment, even if the movement route, which is initially determined by the route plan, is not followed, movement for arriving at the pallet PA from any position after movement can be achieved without estimating the self-positional attitude of the vehicle 1 and without performing position correction movement that is not necessary for following the first movement route.

In particular, in the case of a vehicle has a configuration that is capable of moving in water as described below, it tends to be difficult to estimate the self-positional attitude and follow the initially determined movement route by external reference information, but in such circumstances it is possible to achieve movement control of the vehicle by a route plan for arriving at the object. Also, even on land, in a use case in which the self-position estimation error of the vehicle increases due to some reason, following of the movement route initially determined is also difficult. Even in such a use case, according to the third embodiment, it is possible to achieve movement control of the vehicle by the route plan for arriving at the object.

### Fourth Embodiment

In the fourth embodiment, in addition to the configurations and functions described in the first embodiment, the direct feedback by the second control unit 22 is more specifically defined. In the following description, items similar to those described above are denoted by the same reference signs, and descriptions thereof will be omitted. Note that the direct feedback by the second control unit 22 in the first embodiment is not limited to that described in the fourth embodiment. Also, embodiments in which at least one of the second embodiment and the third embodiment, and the fourth embodiment are merged are also possible.

In the case in which the detection device 10 is a stereo camera like the detection units 11 and 12, direct feedback based on the visual servoing method described above can be employed for direct feedback.

However, the visual servoing method introduced above assumes that the application target is a holonomic vehicle VV. Thus, by simply applying the visual servoing method to the nonholonomic vehicle 1, movement control of the vehicle 1 cannot be achieved.

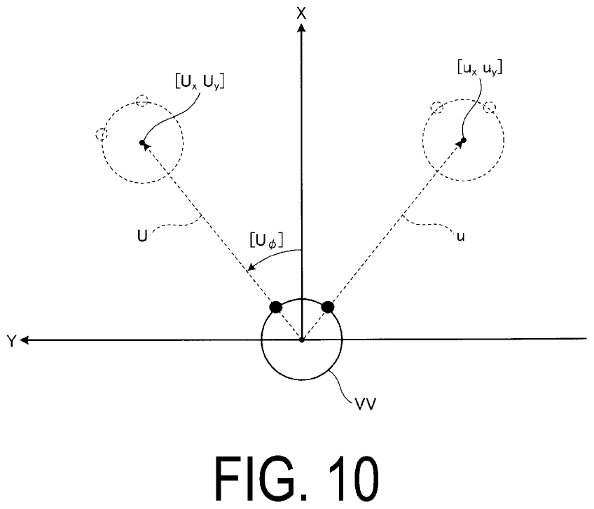

FIG. 10 is a schematic diagram illustrating the mechanism of movement control of the holonomic vehicle VV. Using visual servoing method that assumes the application target is the holonomic vehicle VV, the output of U=[Uₓ U_{y}U_{φ}] indicated in FIG. 10 can be derived according to the input from the detection unit 11 of [X₁¹ Y₁¹]^{T}, [X₁² Y₁²]^{T}, [x₁¹ y₁¹]^{T}, and [x₁² y₁²]^{T} and the input from the detection unit 12 of [Xᵣ¹ Yᵣ¹]^{T}, [Xᵣ² Yᵣ²]^{T}, [xᵣ¹ yᵣ¹]^{T}, and [xᵣ² yᵣ¹]^{T}. Here, of the elements included in U, Uₓ represents the X coordinate after movement due to the output. Also, U_{y} represents the Y coordinate after movement due to the output. Also, U_{φ} represents the amount of change (angle) of the orientation of the vehicle 1 caused by movement due to the output. The same applies to the elements included in u and u′ described below.

The vehicle 1, however, is a nonholonomic vehicle. Assuming that the movement model of the vehicle 1 including the steered wheels FH and the drive wheels RH is an equivalent two-wheel model, each element (Uₓ, U_{y}, U_{φ}) included in U can be converted into an element available in the equivalent two-wheel model as shown in Equation (3) below.

$$[ Equation 2 ]$$

$$\{ \begin{matrix}{U}_{x} = {v}_{ref}^{VS} cos {U}_{ϕ} Δ t \\ {U}_{y} = {v}_{ref}^{VS} sin {U}_{ϕ} Δ t \\ {U}_{ϕ} = \frac{{v}_{ref}^{VS}}{L} tan {ϕ}_{ref}^{VS}\end{matrix} \qquad ( 3 )$$

Based on each element obtained by Equation (3), each element (v_{ref}^{VS} φ_{ref}^{VS}) included in [v_{ref}^{VS}φ_{ref}^{VS}]^{T} is represented as in Equation (4) below.

$$[ Equation 3 ] \begin{matrix}\{ \begin{matrix}{v}_{ref}^{VS} = \sqrt{{U}_{x}^{2} + {U}_{y}^{2}} \\ {ϕ}_{ref}^{VS} = atan \frac{{LU}_{ϕ}}{{v}_{ref}^{VS}}\end{matrix} & ( 4 )\end{matrix}$$

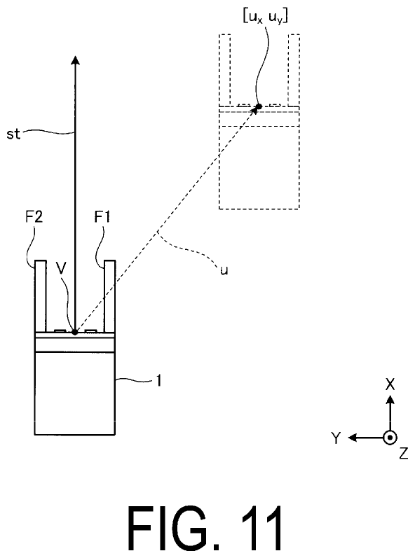

FIG. 11 is a diagram illustrating the displacement between an arrival target position and the position after movement due to the output of the second control unit 22 only according to Equation (3) and Equation (4). Note that the arrival target position is an ideal position after movement (for example, [uₓ u_{y}]) after the holonomic vehicle VV has moved according to the output (for example, u), and serves as the next arrival target position for the current position of the vehicle 1.

When [v_{ref}^{VS}φ_{ref}^{VS}]^{T} is obtained using only Equation (3) and Equation (4), φ_{ref}^{VS} is 0 when U_{φ}=0. On the other hand, the holonomic vehicle VV can move in the X and Y directions on a two-dimensional space (X-Y plane) without changing the orientation of the vehicle. Thus, in the output (U=[Uₓ U_{y} U_{φ}]^{T}) to the holonomic vehicle VV, Uₓ≠0, U_{y}≠0, and U_{φ}=0 may hold true.

In FIGS. 10 and 11, uₓ≠0, u_{y}≠0, and U_{φ}=0 in u=[uₓ u_{y} u_{φ}]^{T}. Even in such cases, substituting u into U in Equation (3) and Equation (4) results in φ_{ref}^{VS}=0. Thus, in such cases, as indicated by an arrow st in FIG. 11, the nonholonomic vehicle 1 to which the equivalent two-wheel model has been applied travels straight. In this case, the nonholonomic vehicle 1 cannot move along u that includes movements in both the X and Y directions.

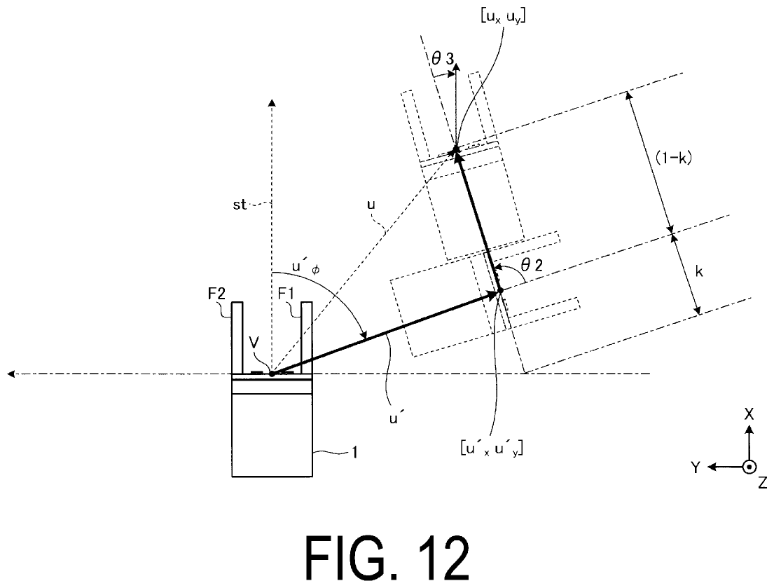

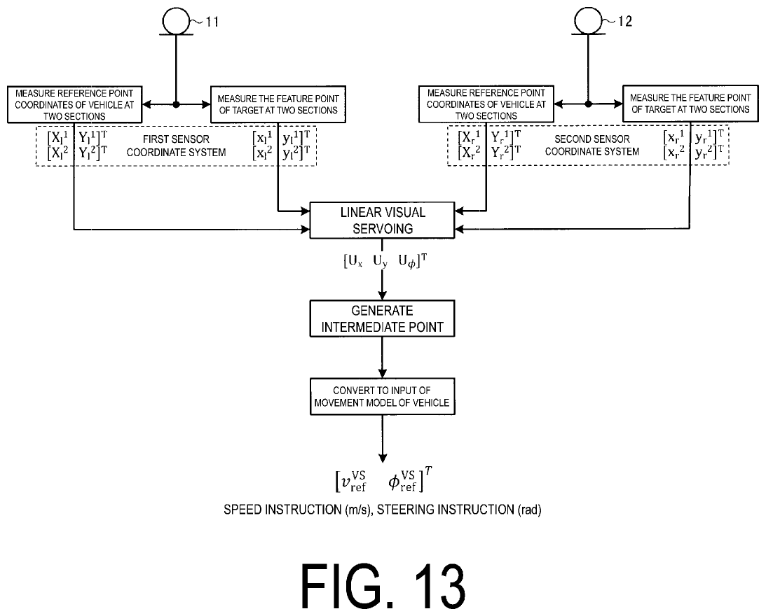

Thus, the second control unit 22 of the fourth embodiment sets an intermediate point between the current position of the vehicle 1 and the arrival target position derived by visual servoing method based on the holonomic vehicle VV, and performs direct feedback that moves the vehicle 1 along a movement route passing through the intermediate point and moving to a position corresponding with U. A case in which the [uₓ u_{y}] illustrated in FIGS. 10 and 11 is the arrival target position will be described with reference to FIGS. 12 and 13.

FIG. 12 is a schematic diagram illustrating a movement route for moving the vehicle 1 through an intermediate point to an arrival target position. FIG. 13 is a diagram illustrating the data flow by the second control unit 22 of the fourth embodiment.

The position of the intermediate point is represented by [u′ₓ u′_{y}]. Assuming that an output to arrive at the intermediate point is u′=[u′ₓ u′_{y} u′_{φ}]^{T}, u′ is obtained by Equation (5), which uses parameter k, described below and Equation (6) described below. Here, k corresponds to an internal division ratio by which a line segment between U and an intersection point is divided by u′, as illustrated in FIG. 12. The intersection point is an intersection of a straight line passing through two points that are the arrival target position and the intermediate point, and a straight line passing through the current position of the vehicle 1 in the Y direction. The length between the intersection point and the arrival target position is defined as 1, the length between the intersection point and the intermediate point is k (0<k<1), and the length between the arrival target position and the intermediate point is (1−k).

More specifically, the second control unit 22 defines an intermediate variable a=[uₓ u_{y}]^{T} and b=[uₓ−u_{y} sin u_{φ}0]^{T}, based on u=[uₓ u_{y} u_{φ}]^{T}. Next, the second control unit 22 sets the value (k) according to the internal division ratio described above, and derives coordinates (c) of the intermediate point according to the following Equation (5).

c=[u′ₓu′_{y}]^{T}=ka+(1−k)b (5)

Next, the second control unit 22 derives the attitude (u′_{φ}) of the vehicle 1 at the intermediate point from the coordinates (c) of the intermediate point, by the following Equation (6). “sign” in Equation (6) is a function that indicates the sign of the argument. Furthermore, the value (k) according to the internal division ratio may be a predetermined value set as the initial setting, or may be dynamically set in a control loop according to an algorithm of the second control unit 22 as a variable and the like dependent on the lateral direction (Y direction) deviation between the position of the vehicle 1 and the arrival target position.

$$[ Equation 4 ]$$

$${u}_{ϕ}^{′} = sign ( {u}_{x}^{′} ) ( asin \frac{{u}_{y}^{′}}{\vert c \vert} - \frac{π}{2} ) \qquad ( 6 )$$

Assuming that, u′ₓ derived by Equation (5) is Uₓ in Equation (3), u′_{y} derived by Equation (5) is U_{y} in Equation (3), and u′_{φ} derived by Equation (6) is U_{φ} in Equation (3). Thus, an output for moving to an intermediate point of ([v_{ref}^{VS} φ_{ref}^{VS}]^{T}) is obtained by Equations (3) and (4).

In this way, by setting the intermediate point, an output of U′_{φ}≠0 is obtained as the output for moving from the position (current position) before the start of movement of the vehicle 1 to the intermediate point. Thus, according to the fourth embodiment, an output of ([v_{ref}^{VS} φ_{ref}^{VS}]^{T}) of direct feedback applicable to the nonholonomic vehicle 1 can be obtained, as illustrated in FIG. 13.

Also, as illustrated in FIG. 12, the orientation of the vehicle 1 at the intermediate point is different from the orientation of the vehicle 1 at the arrival target position. Accordingly, for the movement from the intermediate point to the arrival target position, with the current position set as the intermediate point, the output for moving from the intermediate point to the arrival target position can be derived by direct feedback based on visual servoing method. In other words, by setting the intermediate point, an output of U_{φ}≠0 is obtained even for the output for moving from the intermediate point to the arrival target position.

U_{φ}≠0 means that the vehicle 1 changes orientation with respect to the X and Y directions before arriving at the arrival target position. In the example illustrated in FIG. 12, the movement route is determined so that the orientation changes by (u′_{φ}−θ2+θ3) before the vehicle 1 arrives at the arrival target position from the intermediate point. The angle θ2 is the angle corresponding to the difference between an orientation of the vehicle 1 after the vehicle 1 moves according to u′ and an orientation of the vehicle 1 in traveling straight when the vehicle 1 travels straight from the intermediate point to the arrival target position and arrives at the arrival target position. The angle θ3 is the angle corresponding to the difference between an orientation of the vehicle 1 in traveling straight and an orientation of the vehicle 1 corresponding to u.

In this way, the second control unit 22 of the fourth embodiment sets an intermediate point between the arrival target position and self-position (current position) on the movement route of an imaginary holonomic vehicle capable of movement in all directions, and generates a movement route for moving the vehicle 1 to the arrival target position through the intermediate point. According to the fourth embodiment, an output of ([v_{ref}^{VS}φ_{ref}^{VS}]^{T}) corresponding to the movement from the current position to the arrival target position, which is the output of direct feedback applicable to the nonholonomic vehicle 1, can be obtained.

### Fifth Embodiment

In the fifth embodiment, in addition to the configurations and functions described in the first embodiment, the configuration for moving the vehicle 1 from an undetectable position to a detectable position is more particularly defined. An undetectable position refers to a position of the vehicle 1 where the pallet PA cannot be detected by the detection device 10. A detectable position refers to a position of the vehicle 1 where the pallet PA can be detected by the detection device 10. In the following description, items similar to those described above are denoted by the same reference signs, and descriptions thereof will be omitted. Note that embodiments in which the fifth embodiment is merged with at least one of the second embodiment, the third embodiment, or the fourth embodiment are also possible.

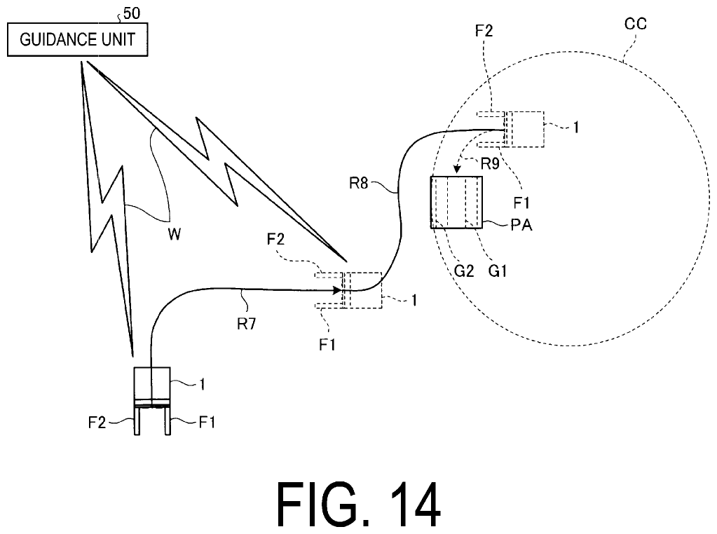

FIG. 14 is a schematic diagram illustrating the relationship between a guidance unit 50 and the vehicle 1. Note that in FIG. 14, the movement route of the vehicle 1 according to the guidance of the guidance unit 50 is defined as movement routes R7 and R8, and the movement route determined by the vehicle 1 on the basis of only the detection result of the detection device 10, not depending on the guidance of the guidance unit 50, is defined as movement route R9. In FIG. 14, the pallet PA can be detected by the detection device 10 when it is inside a region CC indicated by the dashed line, and the pallet PA cannot be detected by the detection device 10 when it is outside the region CC.

The control system of the vehicle 1 according to the fifth embodiment includes the control system SS illustrated in FIG. 1 and the guidance unit 50 illustrated in FIG. 14. The guidance unit 50 guides the vehicle 1 to bring the vehicle 1 close to the pallet PA when the pallet PA is outside of the detection range of the detection device 10. That is, the guidance unit 50 determines the movement route of the vehicle 1 outside the region CC.

Specifically, the guidance unit 50 is an information processing device that stores reference information for determining the movement route of the vehicle 1 outside the region CC. To give a more specific example, in the case in which the vehicle is a forklift like vehicle 1, the guidance unit 50 stores map information and the like through which the conditions in a travel region, where the forklift travels, can be known as reference information. The knowledge of the position of the vehicle 1 in the travel region may be based on the sensing information of the surroundings of the vehicle 1 obtained by the detection device 10 or may be a configuration for knowing the position of the vehicle 1 (such as a sensor, a camera, or the like) provided in the travel region or on the vehicle 1 as a configuration separate to the detection device 10. Furthermore, the guidance unit 50 is provided so as to be able to known the position of the pallet PA. When the position of the pallet PA is predetermined, the guidance unit 50 stores information indicative of the predetermined position of the pallet PA. In addition, in the case in which the position of the pallet PA is not predetermined, the guidance unit 50 includes a configuration (such as a sensor, a camera, or the like) for detecting the position of the pallet PA in the travel region. The guidance unit 50 determines the movement route of the vehicle 1 outside the region CC based on such reference information, position information of the vehicle 1 identified by the detection device 10 or the configuration for knowing the position of the vehicle 1 separate from the detection device 10, and the position information of the pallet PA.

The positioning accuracy of the vehicle 1 by the guidance unit 50 is not required to be highly accurate as the positioning accuracy of the control system SS, and even if required, this is difficult to achieve. The guidance unit 50 is only required to be capable of guiding the vehicle 1 into the region CC. As the switching condition for switching from guidance of the vehicle 1 by the guidance unit 50 to determining the movement route of the vehicle 1 by the control system SS, a case in which the detection device 10 detected the pallet PA may be used or a case in which the vehicle 1 moved into the predetermined region CC may be used. In the case in which the region CC is predetermined, the region CC is, for example, a region where the pallet PA is located (for example, near the end of a pipe line) in the travel region of the vehicle 1 indicated by the map information stored in the guidance unit 50.

Note that in FIG. 14, the guidance unit 50 and the vehicle 1 communicate via the wireless signal W, but the specific configuration for communication of information between the guidance unit 50 and the vehicle 1 may be wired. In such a case, the outside of the region CC is a range (distance between the guidance unit 50 and the vehicle 1) where wired communication is possible, and the inside of the region CC is a range where wired communication is not possible.

The fifth embodiment achieves movement control that does not require information from an external source relating to the self-positional attitude of the vehicle when performing final positioning of the vehicle 1 with respect to the pallet PA, and also provides an option to employ movement control to bring the vehicle 1 close to the pallet PA within a range where information from an external source can be used.

The embodiments and modified examples described herein are merely illustrative and are not intended to limit the scope of the invention. These embodiments and modified examples may be implemented in various other forms, and various omissions, substitutions, and alterations may be made without departing from the gist of the invention. These embodiments and modified examples are included in the scope and gist of the invention and are also included in the scope of the invention described in the claims and equivalents thereof.

For example, the vehicle 1 is not limited to being a forklift. The vehicle 1 includes nonholonomic vehicles in general with a distance-measuring sensor. Specifically, the vehicle 1 may have a configuration, that is provided to be capable of movement in at least one region of land, ocean, or air, such as an automobile, marine vessel, or an aircraft. Accordingly, the specific configuration of the drive unit 31, the steering unit 32, the driven unit 41, and the steered unit 42 may be a configuration in which active movement in the Z direction is capable. That is, the vehicle is only required to have a configuration in which nonholonomic movement in at least the X-Y plane is capable.

The specific configuration of the guidance unit 50 corresponds to the specific configuration of the vehicle 1. In the case in which the vehicle 1 is a forklift, an example of the specific configuration employed as the guidance unit 50 includes an in-area movement management system of a warehouse area where the vehicle 1 is assumed to move. Also, in the case in which the vehicle 1 is a vehicle that is capable of moving on or under the water, an example of the specific configuration employed as the guidance unit 50 includes a mother ship or a management base station of the vehicle.

In addition, the object at which the vehicle 1 arrives by movement is not limited to the pallet PA. The object may be an actively or passively movable object.

Furthermore, the specific configuration of the detection device 10 is not limited to a configuration including the detection units 11 and 12. The detection device 10 may have a configuration that includes a light projector, a light receiver, or the like provided for sensing the object by light detection and ranging (LiDAR), or a configuration which is capable of knowing the relationship between the vehicle 1 and the object by detecting electromagnetic waves or sound waves, such as radar or sonar. Note that, in the case in which the detection device 10 has a configuration other than a stereo camera, the first sensor coordinate system and the second sensor coordinate system input to the first control unit 21 and the second control unit 22 in FIG. 5, and the first sensor coordinate system and the second sensor coordinate system input to the second control unit 22 in FIG. 13 are substituted by a sensor coordinate system ([X¹ Y¹]^{T}, [X² Y²]^{T}, [x¹ y¹]^{T}, and [x² y²]^{T} output from the configuration.

Also, regardless of the specific configuration of the detection device 10, the detection device 10 is provided to be able to detect two reference points of the vehicle 1 and two feature points of the pallet PA. However, it is not necessary that all of the two reference points of the vehicle 1 and all of the two feature points of the pallet PA are detectable by one device. For example, one of two or more configurations, in which a placement is known in advance by the vehicle 1, may detect a part of the two reference points of the vehicle 1 and the two feature points of the pallet PA, and the other one or more configurations may detect the remaining of the two reference points of the vehicle 1 and the two feature points of the pallet PA.

Also, the control device 20 may not be mounted on the vehicle 1. The vehicle with the detection device 10 and the control device 20 may be connected through a communication path that is wired, wireless, or both using together.

Furthermore, the drive unit 31, the steering unit 32, the driven unit 41, and the steered unit 42 are not limited to a configuration in which an equivalent two-wheel model is applied. For example, so-called 4WD or 4WDS may be applied, or configuration capable of propulsion and steering without wheels may be used. The performance specifications of the vehicle 1 according to the driving and steering method are set in advance as constraint conditions of the control device 20, the first control unit 21, and the second control unit 22.

The second embodiment and the modified examples can be employed as a method that allows better control corresponding to the various conditions (use case) required on the basis of the specific configuration of the vehicle and object and the specifications of the vehicle. This allows for faster and more accurate positioning of the vehicle.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A vehicle control system configured to cause a vehicle to arrive at an object with satisfying required conditions for a position and orientation of the vehicle in a two-dimensional plane when the vehicle arrives at the object corresponding to a position and orientation of the object in the two-dimensional plane, the vehicle control system comprising:
a detection device provided on the vehicle, the detection device being configured to detect a positional relationship between two reference points of the vehicle and two feature points of the object; and
a control device configured to determine a movement route of the vehicle on the basis of only information indicative of the positional relationship detected by the detection device, wherein
the control device includes
a first control unit configured to generate a route plan on the basis of information indicative of the positional relationship and determine the movement route according to the route plan, and
a second control unit configured to determine the movement route by direct feedback on the basis of information indicative of the positional relationship, and
the first control unit and the second control unit are provided to be switchable on the basis of the positional relationship, in determining the movement route.

2. The vehicle control system according to claim 1, wherein
the control device
determines the movement route by the second control unit when the vehicle arrives in a switching region where the vehicle can be caused to arrive at the object with satisfying the conditions under movement and steering constraints of the vehicle, and
determines the movement route by the first control unit when the vehicle is outside the switching region.

3. The vehicle control system according to claim 2, wherein
the switching region is facing the object with respect to the orientation of the object.

4. The vehicle control system according to claim 2, wherein
the switching region is predetermined on the basis of specifications of the vehicle.

5. The vehicle control system according to claim 1, wherein
the first control unit updates the route plan at a predetermined time period.

6. The vehicle control system according to claim 1, wherein
the second control unit sets an intermediate point between an arrival target position and a self-position on a movement route of an imaginary holonomic vehicle capable of movement in all directions and generates a movement route for moving the vehicle to the arrival target position through the intermediate point.

7. The vehicle control system according to claim 1, further comprising
a guidance unit configured to guide the vehicle to move close to the object when the object is outside a detection range of the detection device.

8. A vehicle control method for causing a vehicle to arrive at an object with satisfying required conditions for a position and orientation of the vehicle in a two-dimensional plane when the vehicle arrives at the object corresponding to a position and orientation of the object in the two-dimensional plane, the vehicle control method comprising:
detecting a positional relationship between two reference points of the vehicle and two feature points of the object, provided in the vehicle; and
determining a movement route on the basis of only information indicative of the positional relationship detected in the detecting, wherein
in the determining,
a first control, in which a route plan is generated on the basis of information indicative of the positional relationship and the movement route is determined according to the route plan, and a second control, in which the movement route is determined by direct feedback on the basis of information indicative of the positional relationship, are switchable on the basis of the positional relationship in determining the movement route.

9. A non-transitory computer-readable recording medium storing a program for causing an information processing device to implement a function that causes a vehicle to arrive at an object with satisfying required conditions for a position and orientation of the vehicle in a two-dimensional plane when the vehicle arrives at the object corresponding to a position and orientation of the object in the two-dimensional plane, the program causing the information processing device to function as:
a control means configured to determine a movement route on the basis of only information indicative of a positional relationship detected by a detection device provided on the vehicle, the detection device being configured to detect a positional relationship between two reference points of the vehicle and two feature points of the object, wherein
the control means includes
a first control unit configured to generate a route plan on the basis of information indicative of the positional relationship and determine the movement route according to the route plan, and
a second control unit configured to determine the movement route by direct feedback on the basis of information indicative of the positional relationship, and
the first control unit and the second control unit are switchable on the basis of the positional relationship in determining the movement route.
